(19) United States
(12) Patent Application Publication
(10) Pub. No.: US 2024/0088692 A1
(43) Pub. Date: Mar. 14, 2024

(54) BATTERY STATUS DETECTION USING FORCED BATTERY MODE

(71) Applicant: Renesas Electronics America Inc., Milpitas, CA (US)

(72) Inventors: Sungkeun Lim, Apex, NC (US); Chong Han, Cary, NC (US); Fengshuan Zhou, Cary, NC (US)

(73) Assignee: Renesas Electronics America Inc., Milpitas, CA (US)

(21) Appl. No.: 18/064,316

(22) Filed: Dec. 12, 2022

Related U.S. Application Data
(60) Provisional application No. 63/405,130, filed on Sep. 9, 2022.

(51) Int. Cl. H02J 7/00

(52) U.S. Cl. CPC H02J 7/007

(57) ABSTRACT

Systems and methods for operating a battery charger are described. A controller of a battery charger can switch an operation mode of a battery charger to a forced battery mode. The controller can detect whether the operation mode successfully switched to the forced battery mode or failed to switch to the forced battery mode. The controller can, in response to the operation mode successfully switched to the forced battery mode, determine the battery charger is connected to a battery. The controller can, in response to the operation mode failed to switch to the forced battery mode, determine an occurrence of a failure condition associated with the battery charger.

### CROSS-REFERENCE TO RELATED APPLICATION

The present application claims the benefit of U.S. Patent Application No. 63/405,130, titled “AN INNOVATIVE SOFTWARE BATTERY DETECTION METHOD USING FORCED BATTERY MODE” and filed on Sep. 9, 2022, which is hereby incorporated by reference in its entirety.

### BACKGROUND OF THE SPECIFICATION

The present disclosure relates in general to semiconductor devices. More specifically, the present disclosure relates to using a forced battery mode of a battery charger to detect a status of a battery.

A battery charging device can include a battery pack having at least one battery, a battery charger integrated circuit (IC), a switching circuit, and a controller. When the battery charging device is connected to a power source, sometimes through an adapter, the battery charger IC can drive the switching circuit to provide power from the power source to the battery, thus charging batteries in the battery pack. The controller can obtain various quantitative measurements related to the battery pack for optimizing performances of the battery charger, such as efficiency and power consumption, and to prevent hazardous conditions related to the battery charger.

### SUMMARY

In one embodiment, a method for operating a battery charger is generally described. The method can include switching an operation mode of a battery charger to a forced battery mode. The method can further include detecting whether the operation mode successfully switched to the forced battery mode or failed to switch to the forced battery mode. The method can further include, in response to the operation mode successfully switched to the forced battery mode, determining the battery charger is connected to a battery. The method can further include, in response to the operation mode failed to switch to the forced battery mode, determining an occurrence of a failure condition associated with the battery charger.

In one embodiment, a semiconductor device for operating a battery charger is generally described. The semiconductor device can include an integrated circuit configured to control an operation mode of a battery charger and a controller. The controller can be configured to operate the integrated circuit to switch the operation mode to a forced battery mode. The controller can be further configured to detect whether the operation mode successfully switched to the forced battery mode or failed to switch to the forced battery mode. The controller can be further configured to, in response to the operation mode successfully switched to the forced battery mode, determine the battery charger is connected to a battery. The controller can be further configured to, in response to the operation mode failed to switch to the forced battery mode, determine an occurrence of a failure condition associated with the battery charger.

In one embodiment, an apparatus for operating a battery charger is generally described. The apparatus can include a battery, a battery charger configured to charge the battery, and a controller. The controller can be configured to switch an operation mode of the battery charger to a forced battery mode. The controller can be further configured to detect whether the operation mode successfully switched to the forced battery mode or failed to switch to the forced battery mode. The controller can be further configured to, in response to the operation mode successfully switched to the forced battery mode, determine the battery charger is connected to a battery. The controller can be further configured to, in response to the operation mode failed to switch to the forced battery mode, determine an occurrence of a failure condition associated with the battery charger.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram showing an apparatus that can implement battery status detection using forced battery mode in one embodiment.

FIG. 2 is a diagram a flowchart of an example process that can implement battery status detection using forced battery mode in one embodiment.

FIG. 3A is a diagram showing a waveform of a successful switch to a forced battery mode in one embodiment.

FIG. 3B is a diagram showing a waveform of a failure to switch to a forced battery mode in one embodiment.

FIG. 4 is a diagram a flowchart of an example process that can implement battery status detection using forced battery mode in one embodiment.

### DETAILED DESCRIPTION

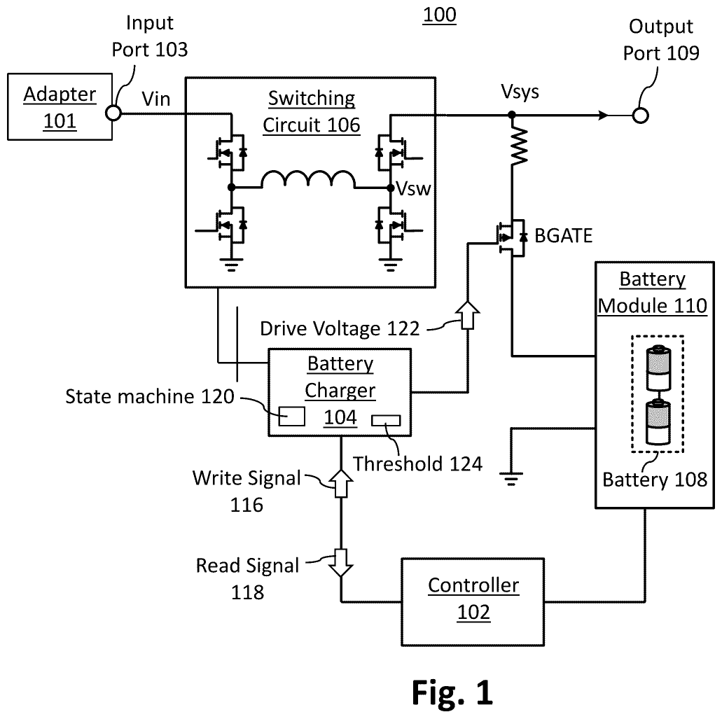

FIG. 1 is a diagram showing an apparatus that can implement battery status detection using forced battery mode in one embodiment. An apparatus 100, shown in FIG. 1, can include a controller 102, a battery charger 104, a switching circuit 106, and a battery module 110. Apparatus 100 can be an electronic device, such as, for example, a battery charging device, a desktop computer, a laptop computer, a tablet device, a smartwatch, a cellular phone, a smartphone, a wearable device, an e-cigarette, or the like. Battery module 110 can be a battery pack including at least one battery 108. Switching circuit 106 can include a plurality of switches, such as metal-oxide-semiconductor field-effect transistors (MOSFET). In one or more embodiments, the switches in switching circuit 106 can be arranged as 4-switch buck-boost converter, 2-switch buck converter, 2-switch boost converter, or other similar configurations.

Controller 102 can be a microcontroller configured to provide control signals (e.g., pulse width modulation (PWM) control signals) to battery charger 104. Battery charger 104 can be an integrated circuit (IC) including various components that can be operated to facilitate charging battery 108 and providing power to battery 108 and/or load that can be connected to an output port 109 of apparatus 100. For example, battery charger 104 can include drivers configured to use the PWM control signals, provided by controller 102, to drive the switches in switching circuit 106. When a power supply is connected to an input port 103 of apparatus 100, via an adapter 101, the switches in switching circuit 106 can be driven by the PWM signals to convert an input voltage (Vin) of power being supplied by the power supply into a system voltage Vsys (or output voltage), and battery 108 in battery module 110 can be charged by Vsys.

A switch BGATE (e.g., a metal-oxide-semiconductor field-effect transistor (MOSFET)) can be connected between an output of apparatus 100 (e.g., Vsys) and battery module 110. Battery charger 104 can be configured to send a drive voltage 122 to drive a gate of BGATE. When BGATE is switched on by drive voltage 122, battery module 110 can be connected to output Vsys. If adapter 101 is connected to input port 103 and BGATE is switched on, then battery 108 in battery module 110 can be charged by Vsys. If adapter 101 is disconnected from input port 103 and BGATE is switched on, then battery 108 in battery module 110 can supply power to Vsys.

Battery charger 104 can include a state machine 120. In one embodiment, battery charger 104 can include at least one memory device, such as registers, configured to store state machine 120. In one embodiment, battery charger 104 can include firmware that can store state machine 120. State machine 120 can be a behavioral model composed of states and transitions between the states, and each state can be enabled by fulfillment of a predefined condition. Battery charger 104 can operate in accordance with a selected state of state machine 120. In one embodiment, state machine 120 can include at least a system voltage (Vsys) mode, a charging mode, a battery mode, and a forced battery mode.

When battery charger 104 operates in system voltage mode, battery charger 104 can switch off BGATE and drive the switches in switching circuit 106 such that Vsys can be supplied by power from adapter 101. If a load is connected to output port 109, then the load can be powered directly by the adapter 101. When battery charger 104 operates in charging mode, battery charger 104 can switch on BGATE and drive the switches in switching circuit 106 such that Vsys can be supplied by power from adapter 101 and battery 108 can be charged by the power provided by adapter 101.

When battery charger 104 operates in battery mode, adapter 101 is not connected to input port 103 and battery charger 104 does not drive switching circuit 106 (e.g., switching circuit 106 is disabled). Battery charger 104 can switch on BGATE and Vsys can be supplied by battery 108. When battery charger 104 operates in forced battery mode, adapter 101 is connected to input port 103 and battery charger 104 does not drive switching circuit 106 (e.g., switching circuit 106 is disabled). Battery charger 104 can switch on BGATE and Vsys can be supplied by battery 108. In forced battery mode, battery charger 104 can maintain switching circuit 106 in an off state and switch on BGATE regardless of whether adapter 101 is connected to switching circuit 106.

Each state in state machine 120 can correspond to a respective state machine code. The state machine code can be stored in a register in battery charger 104. Controller 102 can be configured to send a write signal 116 to write a state machine code to the register to change an operation mode of battery charger 104. Controller 102 can also be configured to read the state machine code stored in the register to determine a current operation mode of battery charger 104. In one embodiment, to read the register in battery charger 104, controller 102 can request battery charger 104 to provide read signal 118 that encodes the current operation mode of battery charger 104.

In some aspects, apparatus 100 can encounter various failure conditions associated with battery module 110. For example, battery module 110 can be disconnected from B GATE (or from Vsys), or battery 108 can be fully drained without being noticed. In an aspect, apparatus 100 may not function correctly if there is a disconnection between battery module 110 and BGATE or Vsys (or output port 109). In an aspect, battery voltage of battery 108 can be monitored to detect the disconnection. However, the monitored battery voltage may need to be read out by a battery charger as a digital signal and some battery chargers may not include analog-digital-converters (ADC) for reading out the battery voltage. Further, ADCs can occupy significant amount of circuit board space, thus it may not be desirable to add ADCs to battery chargers for some applications.

To detect failure conditions, conventional controllers can be programmed to read the battery voltage from a battery pack, but there can be confusion between different failure conditions. For example, a low battery voltage can be indicative of the disconnection between the battery pack and BGATE, and can also be indicative of a dead battery in the battery pack, or a fully drained battery. Further, in some aspects, a connection status between the battery pack and B GATE can be unnoticed to the controller due to reasons such as poor contact on a connector of the battery pack, broken connector on the battery pack, battery management system of the battery pack failing to report battery wakeup or sleep status, and/or the battery charger does not have an ADC to read battery voltage level.

In one or more embodiments, failure conditions associated with battery module 110 can be detected by controller 102 without adding hardware components and without a need to continuously monitor battery voltage. Controller 102 can be configured to write to, and read from, registers in battery charger 104 in order to detect various status of battery module 110. In one embodiment, battery charger 104 can include a register storing a threshold 124. Threshold 124 can be a voltage value that can be adjustable by controller 102. In one embodiment, the register storing threshold 124 can be a register that is assigned for storing the minimum value of Vsys. Thus, the adjustment to threshold 124 performed by controller 102 can be an adjustment of the minimum value of Vsys.

To detect failure conditions associated with battery module 110, controller 102 can adjust threshold 124 and set a state of state machine 120 to switch battery charger 104 to operate in forced battery mode. Controller 102 can read a state of state machine 120 to determine whether battery charger 104 successfully switched to forced battery mode or failed to switch to forced battery mode. Based on whether battery charger 104 switched to forced battery mode or failed to switch to forced battery mode, controller 102 can determine a status of battery module 110 and determine a presence or absence of failure conditions associated with battery module 110. If battery charger 104 successfully switched to forced battery mode, then controller 102 can determine that battery module 110 is operating correctly, such as battery module 110 is still connected to BGATE. If battery charger 104 failed to switch to forced battery mode, then controller 102 can determine that there may be a failure condition associated with battery module 110, such as a disconnect between battery module 110 and BGATE, and/or battery 108 may be fully drained.

In an aspect, if a battery voltage (e.g., voltage measured between battery module 110 and BGATE) of battery module 110 is greater than a minimum value of Vsys, then battery charger 110 can operate under forced battery mode. If the battery voltage of battery module 110 is less than a minimum value of Vsys, then battery charger 110 cannot operate under forced battery mode despite the state of state machine 120 being set to forced battery mode. Battery charger 104 successfully switching to forced battery mode can indicate that the battery voltage of battery module 110 is greater than Vsys min (or threshold 124). Battery charger 104 failing to switch to forced battery mode can indicate that the battery voltage of battery module 110 is less than Vsys min (or threshold 124). The battery voltage of battery module 110 being less than Vsys min can indicate a failure condition such as disconnection between battery module and B GATE. Therefore, using Vsys min as threshold 124 and detecting whether battery charger 104 switches to forced battery mode or not can allow controller 102 to detect connection status of battery module 110 without monitoring exact values of the battery voltage of battery module 110.

Further, controller 102 can adjust threshold 124 to different values in order to detect different failure conditions associated with battery module 110. In one embodiment, in response to detecting potential failure condition of battery module 110 based on threshold 124 being set to minimum value of Vsys, controller 102 can further lower threshold 124 to detect additional failure conditions such as dead battery or a fully drained battery in battery module 110.

Hence, the systems and methods described herein can provide a relatively simple technique to detect battery failure conditions by adjusting register settings and reading state machines, and can be a cost-effective approach because additional hardware components are not required and existing circuitry does not need to be modified.

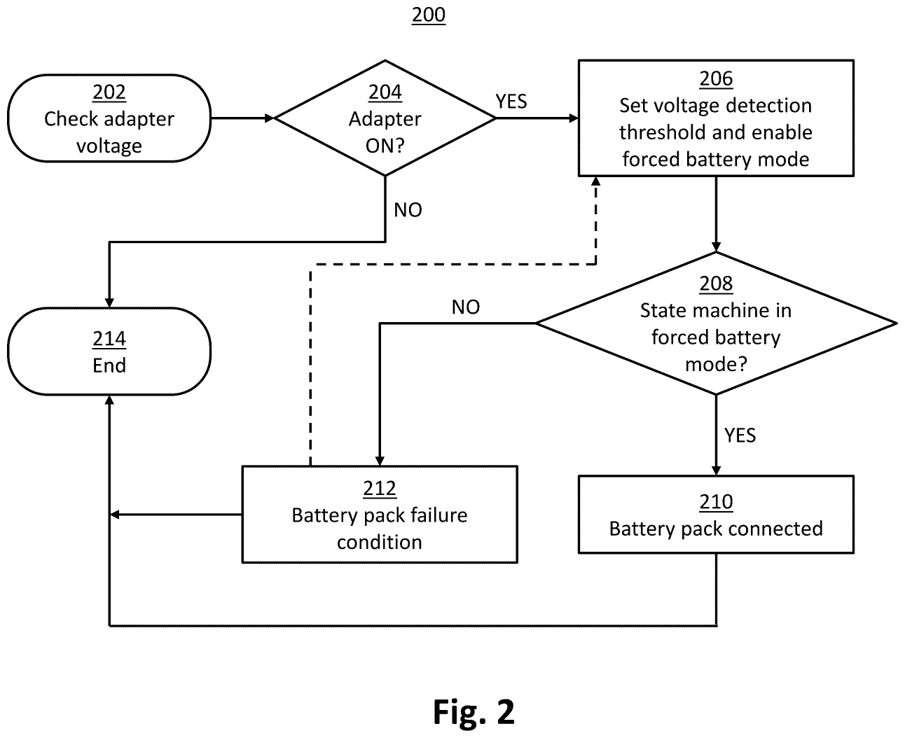

FIG. 2 is a diagram a flowchart of an example process that can implement battery status detection using forced battery mode in one embodiment. A process 200 in FIG. 2 may be implemented using, for example, controller 102 of apparatus 100 discussed above. Process 200 can include one or more operations, actions, or functions as illustrated by one or more of blocks 202, 204, 206, 208, 210 and/or 212. Although illustrated as discrete blocks, various blocks may be divided into additional blocks, combined into fewer blocks, eliminated, performed in different order, or performed in parallel, depending on the desired implementation. The description of FIG. 2 can refer to components shown in FIG. 1.

Process 200 can be a battery status detection process, performed by controller 102. For determining various status and/or failure conditions of a battery pack (e.g., battery module 110). Process 200 can begin at block 202. At block 202, controller 102 can check an adapter voltage. For example, controller 102 can detect the adapter voltage by monitoring a voltage level at input port 103. Process 200 can proceed from block 202 to block 204. At block 204, controller 102 can determined whether adapter 101 is connected and/or switched on based on the voltage level being monitored at block 202. If the voltage level monitored at block 202 is zero, or below a predetermined voltage for indicating a connected adapter is switched off (e.g., adapter 101 can be connected but switched off, resulting in some parasitic voltage), then controller 102 can determine that adapter 101 is not connected to input port 103, or adapter 101 is connected to input port 103 but switched off. In response to controller 102 determining adapter 101 is not connected or connected but switched off, process 200 can proceed from block 204 to block 214 to end the battery status detection process.

If the voltage level monitored at block 202 is nonzero, or above the predetermined voltage for indicating a connected adapter is switched off, then controller 102 can determine that adapter 101 is connected to input port 103. In response to controller 102 determining adapter 101 is connected, process 200 can proceed from block 204 to block 206. At block 206, controller 102 can set a voltage detection threshold (e.g., threshold 124) and enabled battery charger 104 to operate in forced battery mode. In one embodiment, at block 206, controller 102 can set the voltage detection threshold to a minimum Vsys value of apparatus 100. Controller 102 can write to a register in battery charger 104 storing a state of state machine 120 to enable forced battery mode.

Process 200 can proceed from block 206 to block 208. At block 208, controller 102 can read a register in battery charger 104 that indicates a state of state machine 120. The state being read by controller 102 can indicate whether state machine 120 is in forced battery mode or not. If state machine 120 is in forced battery mode, then controller 102 can determine that battery charger 104 successfully switched to forced battery mode. If battery charger 104 successfully switched to forced battery mode, then process 200 can proceed from block 208 to block 210. At block 210, in response to determining that battery charger 104 successfully switched to forced battery mode, controller 102 can determine that the battery pack is connected to Vsys and no failure condition is identified. In response to the determination that the battery pack is connected to Vsys and no failure condition is identified, process 200 can proceed from block 210 to block 214 to end the battery status detection process.

If state machine is not in forced battery mode, then controller 102 can determine that battery charger 104 failed to switch to forced battery mode. If battery charger 104 failed to switch to forced battery mode, then process 200 can proceed from block 208 to block 212. At block 212, in response to determining that battery charger 104 failed to switch to forced battery mode, controller 102 can determine that there is a failure condition associated with the battery pack. The failure condition can be, for example, the battery pack being disconnected from Vsys or BGATE, or the battery pack is connected but fully drained.

In one embodiment, in response to the determination that there is a failure condition, process 200 can proceed from block 212 to block 214 to end the battery status detection process. In response to ending the battery status detection process at block 214, controller 102 can output a notification to alert a user of apparatus of the failure condition. For example, controller 102 can output visual and/or audio notifications using components that may be part of, or connect to, apparatus 100 (e.g., light-emitting diode (LED), speaker, display screen, or the like).

In one embodiment, in response to the determination that there is a failure condition, process 200 can return to block 206 from block 212 to set the voltage detection threshold to a new value in order to identify a type of the determined failure condition. In one embodiment, controller 102 can reduce the voltage detection threshold to a voltage level less than minimum Vsys and greater than zero. The new value being set for the voltage detection threshold can be dependent on a battery type of the battery pack. For example, a 2-cell battery can have a minimum Vsys of 5.12 volts (V) and the new value being set by controller 102 can be 2V. If the battery voltage of the battery pack is less than 2V, then the battery pack may be disconnected. If the battery voltage is the battery pack is less than 5.12V but greater than 2V, then the battery pack can be connected but may be fully drained.

Process 200 can repeat block 208 in response to setting the voltage detection threshold to the new value. At block 208, if battery charger 104 successfully switched to forced battery mode based on the new value (e.g., battery voltage is greater than the new value of the voltage detection threshold), then process 200 can proceed to block 210 where controller 102 can determine that the battery pack is connected. Hence, the battery voltage being lower than minimum Vsys but greater than the new value can indicate that the battery pack is connected but may be fully drained or not in a healthy condition (e.g., dead battery). At block 208, if battery charger 104 failed to switch to forced battery mode based on the new value (e.g., battery voltage is less than the new value of the voltage detection threshold), then process 200 can proceed to block 212 where controller 102 can determine that the battery pack is disconnected. Therefore, controller 102 can adjust the voltage detection threshold to different values in order to identify different types of failure condition and/or status of the battery pack.

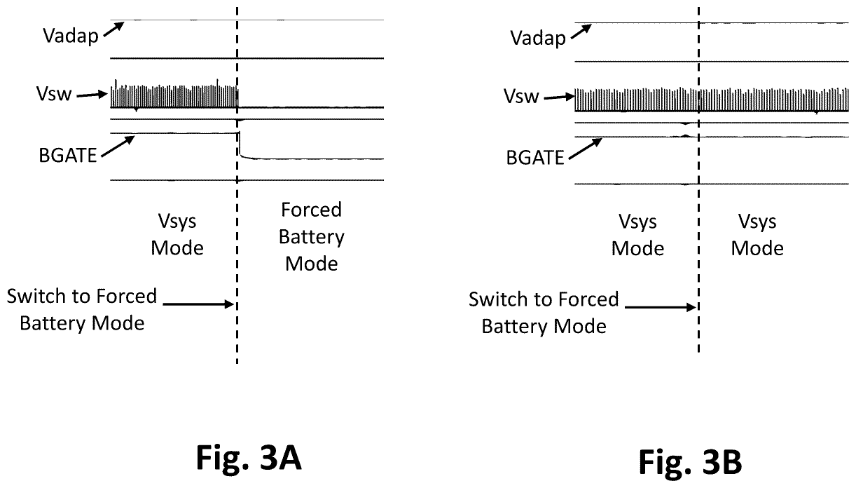

FIG. 3A is a diagram showing a waveform of a successful switch to a forced battery mode in one embodiment. The description of FIG. 3A can reference components of FIG. 1 and FIG. 2. In the waveform shown in FIG. 3A, an adapter voltage Vadap is HIGH, which indicates that adapter 101 is connected and is switched on. Under Vsys mode, BGATE is switched off and switching circuit 106 is switched on, thus a switch voltage Vsw in switching circuit 106 can be pulled up and pulled down alternately. In the example shown in FIG. 3A, BGATE is implemented by a P-type MOSFET, thus BGATE is off when pulled to HIGH, and is on when pull down to LOW. If BGATE is implemented by a N-type MOSFET, then BGATE is on when pulled to HIGH, and is off when pull down to LOW. In response to controller 102 switching battery charger 104 to forced battery mode, a successful switch to forced battery mode can switch on BGATE and switch off switching circuit 106, causing Vsw to be zero (e.g., there is no output from switching circuit 106).

FIG. 3B is a diagram showing a waveform of a failure to switch to a forced battery mode in one embodiment. The description of FIG. 3B can reference components of FIG. 1 and FIG. 2. In the waveform shown in FIG. 3B, adapter voltage Vadap is HIGH, which indicates that adapter 101 is connected and is switched on. Under Vsys mode, BGATE is switched off and switching circuit 106 is switched on, thus a switch voltage Vsw in switching circuit 106 can be pulled up and pulled down alternately. In response to controller 102 switching battery charger 104 to forced battery mode, a failure to switch to forced battery mode can cause BGATE to remain off and switching circuit 106 remains switched on.

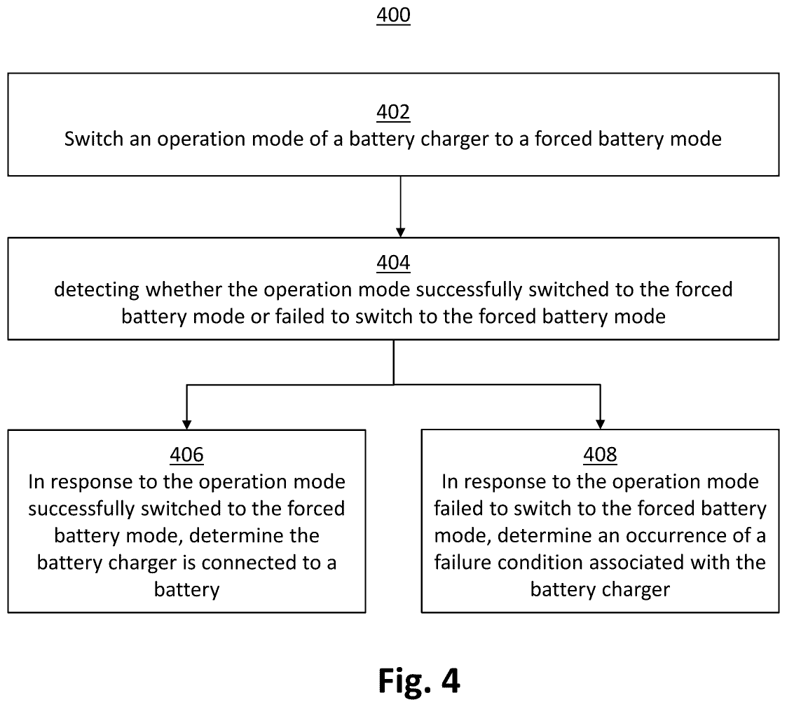

FIG. 4 is a diagram a flowchart of an example process that can implement battery status detection using forced battery mode in one embodiment. A process 400 in FIG. 4 may be implemented using, for example, controller 102 of apparatus 100 discussed above. Process 400 can include one or more operations, actions, or functions as illustrated by one or more of blocks 402, 404, 406, and/or 408. Although illustrated as discrete blocks, various blocks may be divided into additional blocks, combined into fewer blocks, eliminated, performed in different order, or performed in parallel, depending on the desired implementation.

Process 400 can be implemented by a controller of a battery charger. Process 400 can begin at block 402, where a controller can switch an operation mode of a battery charger to a forced battery mode. In one embodiment, the controller can detect an adapter is of the battery charger is enabled. The controller can set a voltage detection threshold to a minimum system voltage of the battery charger. The controller can switch the operation mode to the forced battery mode in response to setting the voltage detection threshold. In one embodiment, the controller can switch the battery charger to the forced battery mode by modifying a register in the battery charger to switch the operation mode to the forced battery mode.

Process 400 can proceed from block 402 to block 404. At block 404, the controller can detect whether the operation mode successfully switched to the forced battery mode or failed to switch to the forced battery mode. In one embodiment, the controller can detect whether the battery charger successfully switched to the forced battery mode or failed to switch to the forced battery mode by reading a register in the battery charger.

In response to the operation mode successfully switched to the forced battery mode, process 400 can proceed from block 404 to block 406. At block 406, the controller can determine the battery charger is connected to a battery. In response to the operation mode failed to switch to the forced battery mode, process 400 can proceed from block 404 to block 408. At block 408, the controller can determine an occurrence of a failure condition associated with the battery charger. In one embodiment, the failure condition can be at least one of the battery charger being disconnected from the battery and the battery being fully drained.

In one embodiment, the controller can, in response to determining the occurrence of a failure condition, set a voltage detection threshold to a new voltage level. The controller can, in response to setting the voltage detection threshold, detect whether the battery charger successfully switched to the forced battery mode or failed to switch to the forced battery mode. The controller can, in response to the battery charger successfully switched to the forced battery mode, determining the battery charger is fully drained. The controller can, in response to the battery charger failed to switch to the forced battery mode, determining the battery charger is disconnected from the battery. In one embodiment, the new voltage level can be less than a minimum system voltage of the battery charger.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for operating a battery charger, the method comprising:
switching an operation mode of a battery charger to a forced battery mode;
detecting whether the operation mode successfully switched to the forced battery mode or failed to switch to the forced battery mode;
in response to the operation mode successfully switched to the forced battery mode, determining the battery charger is connected to a battery; and
in response to the operation mode failed to switch to the forced battery mode, determining an occurrence of a failure condition associated with the battery charger.

2. The method of claim 1, further comprising:
detecting an adapter of the battery charger is enabled; and
setting a voltage detection threshold to a minimum system voltage of the battery charger, wherein switching the operation mode to the forced battery mode is performed in response to setting the voltage detection threshold.

3. The method of claim 1, wherein switching the battery charger to the forced battery mode comprises modifying a register in the battery charger to switch the operation mode to the forced battery mode.

4. The method of claim 3, wherein detecting whether the battery charger successfully switched to the forced battery mode or failed to switch to the forced battery mode comprises reading a register in the battery charger.

5. The method of claim 1, wherein the failure condition is at least one of:
the battery charger being disconnected from the battery; and
the battery being fully drained.

6. The method of claim 1, further comprising:
in response to determining the occurrence of a failure condition, setting a voltage detection threshold to a new voltage level;
in response to setting the voltage detection threshold, detecting whether the battery charger successfully switched to the forced battery mode or failed to switch to the forced battery mode;
in response to the battery charger successfully switched to the forced battery mode, determining the battery charger is fully drained; and
in response to the battery charger failed to switch to the forced battery mode, determining the battery charger is disconnected from the battery.

7. The method of claim 6, wherein the new voltage level is less than a minimum system voltage of the battery charger.

8. A semiconductor device comprising:
an integrated circuit configured to control an operation mode of a battery charger; and
a controller configured to:
operate the integrated circuit to switch the operation mode to a forced battery mode;
detect whether the operation mode successfully switched to the forced battery mode or failed to switch to the forced battery mode;
in response to the operation mode successfully switched to the forced battery mode, determine the battery charger is connected to a battery; and
in response to the operation mode failed to switch to the forced battery mode, determine an occurrence of a failure condition associated with the battery charger.

9. The semiconductor device of claim 8, wherein the controller is configured to:
detect an adapter of the battery charger is enabled; and
set a voltage detection threshold to a minimum system voltage of the battery charger, wherein operate the integrated circuit to switch the operation mode to the forced battery mode is performed in response to setting the voltage detection threshold.

10. The semiconductor device of claim 8, wherein the controller is configured to modify a register in the integrated circuit to switch the operation mode to the forced battery mode.

11. The semiconductor device of claim 8, wherein the controller is configured to read a register in the integrated circuit to detect whether the operation mode successfully switched to the forced battery mode or failed to switch to the forced battery mode.

12. The semiconductor device of claim 8, wherein the failure condition is at least one of:
the battery charger being disconnected from the battery; and
the battery being fully drained.

13. The semiconductor device of claim 8, wherein the controller is further configured to:
in response to determining the occurrence of a failure condition, set a voltage detection threshold to a new voltage level;
in response to setting the voltage detection threshold, detect whether the operation mode successfully switched to the forced battery mode or failed to switch to the forced battery mode;
in response to the operation mode successfully switched to the forced battery mode, determine the battery charger is fully drained; and
in response to the operation mode failed to switch to the forced battery mode, determine the battery charger is disconnected from the battery.

14. The semiconductor device of claim 13, wherein the new voltage level is less than a minimum system voltage of the battery charger.

15. An apparatus comprising:
a battery;
a battery charger configured to charge the battery; and
a controller configured to:
switch an operation mode of the battery charger to a forced battery mode;
detect whether the operation mode successfully switched to the forced battery mode or failed to switch to the forced battery mode;
in response to the operation mode successfully switched to the forced battery mode, determine the battery charger is connected to a battery; and
in response to the operation mode failed to switch to the forced battery mode, determine an occurrence of a failure condition associated with the battery charger.

16. The apparatus of claim 15, wherein the controller is configured to:
detect an adapter of the battery charger is enabled; and
set a voltage detection threshold to a minimum system voltage of the battery charger, wherein switch the operation mode to the forced battery mode is performed in response to setting the voltage detection threshold.

17. The apparatus of claim 15, wherein the controller is configured to modify a register in the battery charger to switch the operation mode to the forced battery mode.

18. The apparatus of claim 15, wherein the controller is configured to read a register in the battery charger to detect whether the operation mode successfully switched to the forced battery mode or failed to switch to the forced battery mode.

19. The apparatus of claim 15, wherein the failure condition is at least one of:
the battery charger being disconnected from the battery; and
the battery being fully drained.

20. The apparatus of claim 15, wherein the controller is further configured to:
in response to determining the occurrence of a failure condition, set a voltage detection threshold to a voltage level below a minimum system voltage of the battery charger;
in response to setting the voltage detection threshold, detect whether the operation mode successfully switched to the forced battery mode or failed to switch to the forced battery mode;
in response to the operation mode successfully switched to the forced battery mode, determine the battery charger is fully drained; and
in response to the operation mode failed to switch to the forced battery mode, determine the battery charger is disconnected from the battery.
